(19) United States
(12) Patent Application Publication
(10) Pub. No.: US 2019/0164201 A1
(43) Pub. Date: May 30, 2019

(54) TRUSTWORTHY REVIEW SYSTEM AND METHOD FOR LEGITIMIZING A REVIEW

(71) Applicant: NEC Europe Ltd., Heidelberg (DE)

(72) Inventor: Claudio Soriente, Villafranca del Castillo (ES)

(21) Appl. No.: 15/822,251

(22) Filed: Nov. 27, 2017

(51) Int. Cl. G06Q 30/02; G06F 17/30; H04L 29/06; G06Q 30/00

(52) U.S. Cl. CPC G06Q 30/0282; G06F 17/30864; G06K 7/1417; G06Q 30/018; H04L 63/126

(57) ABSTRACT

A method for checking legitimacy of a customer review includes receiving, via a service provider device, a verification key and receiving, via a customer device, a customer review, a redacted message, and a redacted signature. The method further includes at least one of: (a) publishing the verification key and the redacted signature on a review website with the customer review such that the legitimacy of the redacted signature is checkable by a user device; or (b) checking, using the verification key, whether the redacted signature is legitimate and, based on the redacted signature being legitimate, marking the customer review as being legitimate.

### FIELD

The present invention relates to a method for providing a legitimate customer review. The present invention also relates to a method for checking legitimacy of a customer review.

### BACKGROUND

Review websites allow users to review goods or services sold by different service providers. Each provider has its own webpage within the review website where users can post reviews. Reviews can be anonymous or can be bound to a user account within the review website system. Given a decentralized nature of the system with multiple service providers and multiple (sometimes anonymous) users, it may be difficult to identify a legitimate review, for example, a review that has been posted by a user who actually purchased the goods or services being reviewed. As such, online review websites are susceptible to fraudulent reviews that create bias in the ranking of the reviewed service providers. Additionally, some companies sell batches of positive or negative reviews that can either improve the reputation of a service provider or harm the reputation of competing stakeholders. Administrators of review websites can do little to combat this due to the anonymous and decentralized nature of the system. Conventional techniques for detecting fake reviewers by behavioral features include, e.g., number of reviews per time period, review length, writing style, etc.

### SUMMARY

An embodiment of the present invention provides a method for checking legitimacy of a customer review. The method includes receiving a verification key via a service provider device and then receiving a customer review, a redacted message, and a redacted signature via a customer device. The method further includes at least one of: (a) publishing the verification key and the redacted signature on a review website with the customer review such that the legitimacy of the redacted signature is checkable by a user device; or (b) checking, using the verification key, whether the redacted signature is legitimate and, based on the redacted signature being legitimate, marking the customer review as being legitimate.

### BRIEF DESCRIPTION OF THE SEVERAL VIEWS OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a system for processing reviews according to an embodiment of the invention;

FIG. 2 is a flow diagram illustrating a method for providing a legitimate review according to an embodiment of the invention; and

FIG. 3 is a flow diagram illustrating a method for checking legitimacy of a customer review according to an embodiment of the invention.

### DETAILED DESCRIPTION

A review website allows users to post and read reviews about service providers and their goods or services. Each service provider has a dedicated page within the website where users post and read reviews about goods or services sold by the service provider. Reviews may be anonymous or provided by registered users, i.e., users that have an account on the review website. Anybody can create a number of accounts within review websites and leave positive or negative reviews at will. Embodiments of the present invention provide solutions to the problem of fraudulent reviews in review websites.

The inventor has recognized that the conventional techniques for detecting fake reviewers by behavioral features have inherent limitations, e.g., if identifying a reviewer as rogue when the number of negative reviews he has submitted is higher than the average number of negative reviewers submitted by possibly honest users, then detection of the rogue reviewer, in this case, can be avoided if the rogue reviewer increases the number of positive reviews he generates. Thus, identifying rogue reviewers based on behavioral features can be easily avoided by avoiding the behavioral features that trigger detections.

In an exemplary embodiment, the present invention provides a method for providing a legitimate customer review. The method comprises receiving, via a service provider device, an authorization token, wherein the authorization token includes a message, a redactable signature, and an encoding of redactable parts of the message; redacting part of the message, based on the encoding of redactable parts, to create a redacted message; generating a redacted signature based on the redactable signature; and providing the redacted message, the redacted signature, and a customer review to a review server. The method minimizes waste of computer resources associated with fraudulent reviews, fake reviews, or spam reviews. Review websites, marketplaces, and other entities store customer reviews in various styles, for example, as numerical ratings, written comments, or videos. By associating customer reviews with cryptography as provided in the method, review websites reduce amount of fraudulent reviews stored in their databases. This in effect reduces storage requirements, improves search algorithms when associating multiple reviews to a certain product, and utilizes a lower bandwidth when transmitting customer reviews to potential buyers through their website. Moreover, while preserving privacy of customers by permitting redaction and allowing for customizability thereof, embodiments of the present invention the trustworthiness of the review system is increased.

In an exemplary embodiment, the present invention introduces an architecture and system that mitigates the threat of fraudulent reviews in review websites. The system provides users with additional confidence that a review of a particular good or service is legitimate, i.e., that it has been contributed by a user who has actually purchased that good or service. In one aspect, along with a customer's receipt, customers receive an authorization token that entitles the customer to review the purchased goods or services. The token allows, either the administrator of the review website or other users, to validate the legitimacy of the review. That is, the token allows the administrator or other users to check that the review is authorized and tied to the purchase of the reviewed goods or services.

In an exemplary embodiment of the present invention, service providers issue authorization tokens to their customers. Similar to a customer's receipt, an authorization token is a publicly verifiable, signed statement issued by a service provider that lists goods or services purchased by the bearer of the token. At the time of posting a review on the review website, the author of the review also uploads the authorization token. Hence, anyone can verify that the review is legitimate, i.e., that it has been posted by a user who actually purchased the goods or services under review from the services provided that issued the token.

In order to improve usability, an exemplary embodiment of the invention utilizes features that protect privacy of a reviewer. In particular, users are can post a review and authorization token of the review to the review website, while hiding one or more entries of the token. Hiding entries of the token does not hinder a member of the public from verifying the token. An analogy to this practice is showing a customer's receipt to another person while redacting some of the purchased items on the receipt. This feature may be used in scenarios where the customer wishes to provide product reviews for one or more purchased goods or services from a service provider, but at the same time, wishes to hide one or more purchased goods or services, included in the same transaction but not being reviewed.

In an embodiment, redactable digital signatures are employed to issue authorization tokens. A. Bilzhause, et al., “Position Paper, The Past, Present and Future of Sanitizable and Redactable Signatures,” ARES (2017), which is hereby incorporated by reference herein, provide background on redactable signatures. A redactable digital signature differs from a standard digital signature in that a signer can mark specific parts of a signed message as redactable. As a result, those parts of the signed message can be censored, while still retaining verifiability of the signature.

In an embodiment of the invention, each service provider has a key-pair used to sign and verify signatures of a redactable digital signature scheme. The key-pair may include a signing key and a verification key. The signing key is a private key available to the service provider, while the verification key is a public key. Dissemination of the verification key can be accomplished, for example, by posting the verification key on a webpage of the service provider within the review website. In order to issue an authorization token to a customer, a service provider uses its signing key to compute a signature on a list of goods/services purchased by the customer and any other data that may be object of review. For example, the signed message may include the date of the purchase. The signature plus the signed message may constitute the authorization token.

In an embodiment, the authorization token is acquired by the customer with his/her computing device. The customer's computing device may be, for example, the customer's mobile device which may include a smart phone, a tablet computer, a laptop computer, and a wearable device like a smartwatch or fitness tracking device. The customer may acquire the authorization token through the computing device by several means. For example, the token can be encoded in a barcode or a quick response code (QR-code) printed on a receipt provided to the customer at the completion of a purchase with the service provider, or the Q-R code may be shown on a video display. The customer uses then the camera of his/her mobile device to take picture of the QR-code issued by the service provider. Alternatively, the authorization token can be transferred from the service provider directly to the computing device of the customer over a wired/wireless media, for example, through email, near field communication (NFC), such as Wi-Fi, BLUETOOTH, and so on.

When the customer posts his/her review, the review is submitted along with the authorization token received by the service provider. As such, anybody (a user or an administrator) viewing the review on their computing device can determine whether at least one or more of the following criteria is true:
a. The signature included in the authorization token is valid.
b. The goods/services mentioned in the review appear in the authorization token.
c. The service provider that issued the authorization token is the one being reviewed.
   In an embodiment, if (a), (b), and (c) are all true, then the review is considered to be legitimate.

In an embodiment, the above criteria (a)-(c) are utilized by users that read a review or by software installed on the users' devices. In some aspects, the criteria may be utilized by one or more administrators of a review website, allowing the administrator to place visual indications or mark legitimate reviews as they are displayed on the webpage of each service provider.

In some embodiments, only an administrator may verify reviews, thus removing a burden of review verification from users visiting the review website and having users trust that the administrator verified each review displayed with a marking. When administrators alone verify reviews, there may be no need to publicly distribute verification keys of the service providers, and additionally, authorization tokens may be hidden from users reading the reviews. Verification keys and authorization tokens may only be made available to administrators of the review website.

In some embodiments, both administrators and users may verify reviews. That is, an administrator of the review website utilizes criteria (a), (b), and (c) to determine whether a review is legitimate and places indicators on reviews found to be legitimate. Reviews are posted with authorization tokens, and verification keys for service providers are made publicly available, so that users visiting the review website can double-check or confirm a legitimacy status of a selected review.

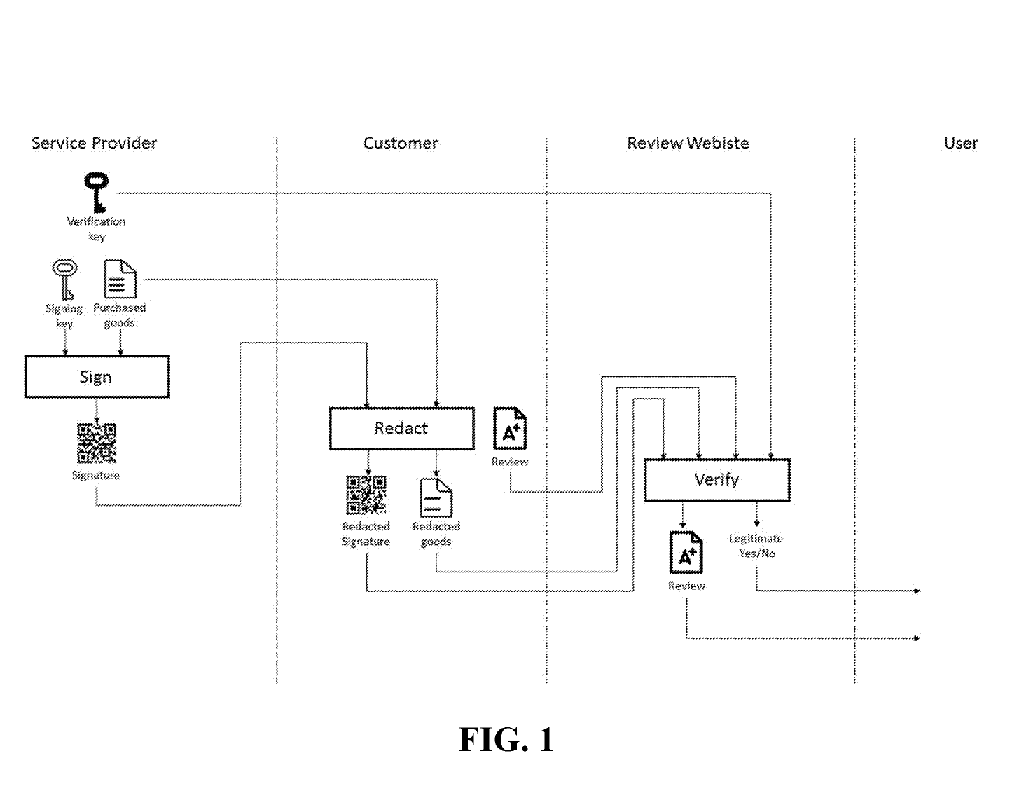

FIG. 1 illustrates a system for processing reviews according to an embodiment of the invention. FIG. 1 identifies four parties—a service provider, a customer, a review website, and a user—that may interface with the system. Although presented as singular entities, it is understood that multiple service providers may conduct business with multiple customers, and the multiple customers may choose to provide reviews of the service providers on multiple review websites. Additionally, the reviews published on these review websites may be viewed by multiple users. Furthermore, note that a service provider may run their own review website, and a customer may view his/her own review.

In the exemplary embodiment of FIG. 1, the system for processing reviews includes computing devices of the service provider, an entity providing goods/services to a customer. The system further includes computing devices of the customer, a recipient of the goods/services provided by the service provider who publicly assesses or evaluates the goods/services by providing a review. The system includes at least one review server, and the review server facilitates displaying a customer's reviews on a user's computing device. In an embodiment of the invention, the review server runs a review website where the review website may contain one or more webpages that display reviews of one or more products. In another embodiment of the invention, the review server interfaces with one or more databases to catalog customer reviews and provides these reviews to one or more applications (or apps) running on a user's computing device. These applications may include browser extensions. The system may include one or more computing devices of users viewing reviews managed by the review server. The system may further include one or more computing devices of administrators managing reviews on the review server. For ease of description, computing devices of the service provider, computing devices of the customer, computing devices of the user, and computing devices of the administrator will be referred to as service provider device(s), customer device(s), user device(s), and administrator device(s), respectively. Singular and plural forms will be used as appropriate.

The system of FIG. 1 uses a redactable signature scheme. The redactable signature scheme includes: key generation (KeyGen), signing (Sign), redaction (Redact), and verification (Verify). In FIG. 1, during KeyGen, the service provider device utilizes a randomized key-generation algorithm that outputs a pair of keys, a signing key and its corresponding verification key.

While conducting business with a customer, the service provider device tracks a list of purchased goods/services by the customer and signs the list using the signing key generated during KeyGen. The list may be include entries such as on a standard purchase receipt. Names should be descriptive of the purchased good or services. The signing process performed by the service provider device involves creating a redactable signature using the signing key and the list of purchased goods. In addition to the list of purchased goods/services, the service provider device may incorporate other information in the creation of the redactable signature. For example, the service provider device may combine the list of purchased goods/services, a serial number, and any additional information like a timestamp. Furthermore, the service provider device may include indicators identifying which parts of the items included in the redacted signature can be redacted.

Formally, during the signing process, the service provider device determines a redactable signature σ, where σ=Sign(Sig_{SP}, m, red). Sign( ) is the signing process; Sig_{SP} is the signing key; m is a message being signed which may include a list of goods/services (g₁, . . . , gₙ), a serial number (sn) that uniquely identifies a among all signatures issued by the service provider device, and any additional information (data) that the service provider device adds to the message, for example, a timestamp for when σ was issued, prices for purchased goods/services, and a location or branch of the service provider where the goods/services were purchased; and red indicates an encoding of which parts of the signed message m can be redacted. In some cases, red may encode an empty set, indicating that no parts of the message m can be redacted. For example, in a case where the service provider does not want to allow the service date to be redacted because the receipt is only relevant for a specific date when a special offer was valid, the customer may not be allowed to redact the date when the goods/services were purchased.

In an embodiment of the invention, the service provider device provides an authorization token t to the customer device. The authorization token t may include parts or all of the message m, the red encoding, and redactable signature σ. In an embodiment of the invention, the authorization token t=[g₁, . . . , gₙ, data, sn, σ, red].

In an embodiment of the invention, the customer device receives the authorization token t and performs a redacting process. During the redacting process, the customer device uses the verification key generated during KeyGen, the authorization token, and an encoding of items within the message in the authorization token to generate a redacted message and a signature on the redacted message.

Formally, during the redacting process, the customer device determines a redacted message m′ and a redacted signature σ′ on the redacted message, where (m′, σ′)=Redact(Ver_{SP}, m, red, mod). Redact( ) is the redacting process; Ver_{SP} is the verification key; m is the signed message obtained from the authorization token t; red indicates an encoding of which parts of the signed message m can be redacted; and mod indicates an encoding of the parts of the message m that the customer device is removing or redacting. Note that the set encoded by mod is a subset of the one encoded by red. In some embodiments, mod can encode the empty set, meaning that no parts of the message m are to be redacted. In this case, Redact( ) outputs the original signature a as the redacted signature and message m as the redacted message.

The customer device may upload or send to the review server a triplet containing the redacted message m′, the redacted signature σ′ on the redacted message, and a review rev of one or more goods/services. The review server may store the triplet in a database for retrieval or provide information in the triplet on a review website for one or more user devices or administrator devices to verify.

In an embodiment, the administrator device checks whether the review obtained by the customer device is legitimate. The administrator device performs a verifying process. During the verifying process, the administrator device utilizes the verification key, the redacted message, and the signature on the redacted message to determine legitimacy of the review. The administrator device may also check the serial number embedded in the redacted message to determine whether the serial number is fresh, that is, whether the serial number has already been encountered during a checking of a previous review. In an embodiment of the invention, if both checks succeed, an administrator device marks the review as legitimate and publishes the review for users to read. In some embodiments, the review server performs the verifying process, running a script and marking as legitimate reviews that pass both checks.

Formally, the administrator device determines whether a verifying process succeeds or fails, that is, the administrator determines whether Verify(Verₛₚ, m′, σ′)=1 is a true statement, where Verify( ) is the verifying process. Verify( ) outputs 1 when σ′ is a valid signature on m′ according to Ver_{SP}, otherwise Verify( ) outputs 0. In an embodiment of the invention, the user device may use Verify( ) to confirm legitimacy of a published review.

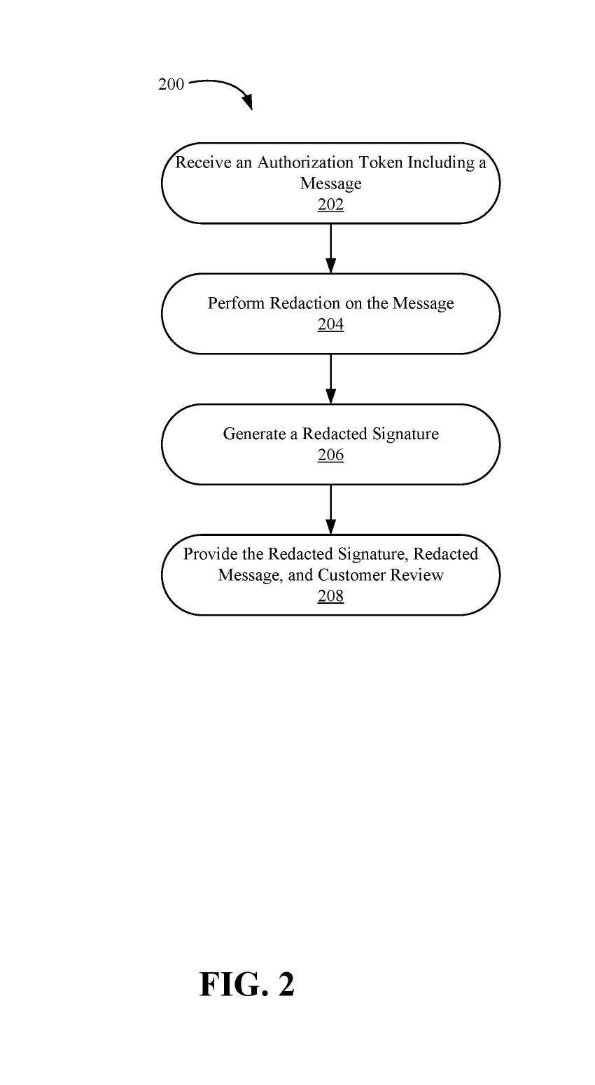

FIG. 2 illustrates a process 200 for providing a legitimate customer review. The process 200 may be performed by a customer device. At step 202, the customer device receives, via a service provider device, an authorization token, wherein the authorization token includes a message, a redactable signature, and an encoding of redactable parts of the message. At step 204, the customer device redacts part of the message, based on the encoding of redactable parts, to create a redacted message. At step 206, the customer device generates a redacted signature based on the redactable signature. The redacted signature is obtained from the redactable signature after defining which parts of the originally signed message are to be redacted. Thus, the redacted signature will differ from the redactable signature based on the redactions to the message made by the customer device. Step 206 can therefore be performed by taking the redactable signature and the signed message, identifying which parts of the message are to be redacted, and therefrom producing the redacted signature. At step 208, the customer device provides the redacted message, the redacted signature, and a customer review to a review server.

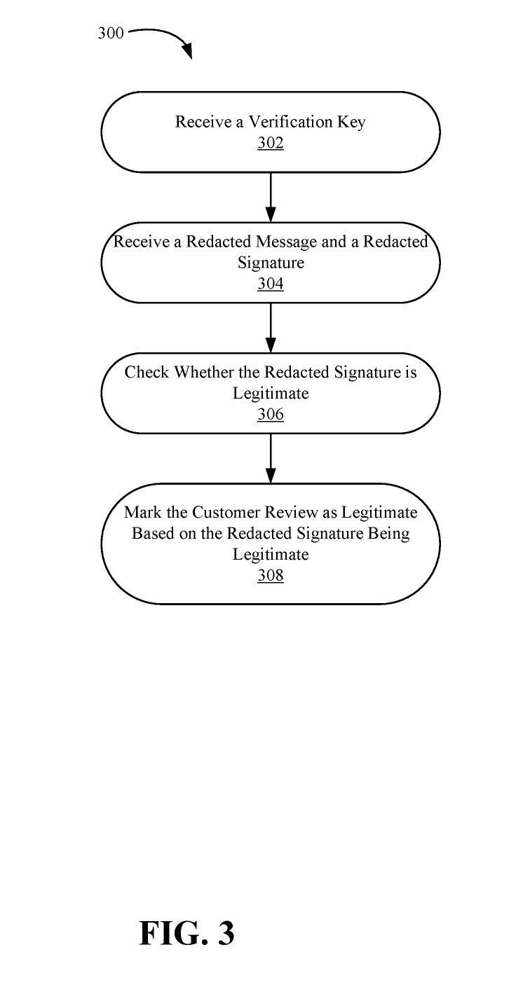

FIG. 3 illustrates a process 300 for checking legitimacy of a customer review. The process 300 may be performed by a review server or an administrator of the review server. At step 302, the review server receives, from a service provider device, a verification key. At step 304, the review server receives, from a customer device, a customer review, a redacted message, and a redacted signature. At step 306, the review server checks, using the verification key, whether the redacted signature is legitimate. At step 308, based on the redacted signature being legitimate, the review server marks the customer review as being legitimate.

Steps 302 through 306 of the process 300 may also be viewed from a user device's perspective. At step 302, the user device receives a verification key from a service provider device. The user device may receive the verification key through the service provider's webpage. At step 304, the user device receives a redacted message and a redacted signature from a review server. The user device may receive the redacted message and the redacted signature from a review website run by the review server. At step 306, the user device checks whether the redacted signature is legitimate.

Embodiments of the invention provide a method for using redactable signatures to provide a privacy-preserving proof of purchase. Redaction of sensitive parts from the privacy-preserving proof of purchase is performed, and verification of the redacted privacy-preserving proof of purchase to check the legitimacy of a review in an online review website can be performed. Embodiments of the invention thus provide cryptographic assurance of the legitimacy of a review.

All references, including publications, patent applications, and patents, cited herein are hereby incorporated by reference to the same extent as if each reference were individually and specifically indicated to be incorporated by reference and were set forth in its entirety herein.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method for checking legitimacy of a customer review, the method comprising:
receiving, via a service provider device, a verification key;
receiving, via a customer device, a customer review, a redacted message, and a redacted signature; and
at least one of:
publishing the verification key and the redacted signature on a review website with the customer review such that the legitimacy of the redacted signature is checkable by a user device; or
checking, using the verification key, whether the redacted signature is legitimate and, based on the redacted signature being legitimate, marking the customer review as being legitimate.

2. The method according to claim 1, wherein the redacted message includes a list of purchased goods and services and/or a serial number.

3. The method according to claim 2, wherein the redacted message includes the serial number, the method further comprising a second check that the customer review is legitimate by checking a database of previously-encountered serial numbers to determine whether the serial number is present.

4. The method according to claim 1, further comprising uploading the legitimate customer review to a review website.

5. The method according to claim 1, further comprising storing the customer review in a review database based on the checking determining that the redacted signature is legitimate and not storing the customer review in the database based on the checking determining that the redacted signature is not legitimate.

6. A method for providing a legitimate customer review, the method comprising:
receiving, via a service provider device, an authorization token, wherein the authorization token includes a message, a redactable signature, and an encoding of redactable parts of the message;
redacting part of the message, based on the encoding of redactable parts, to create a redacted message;
generating a redacted signature using the redactable signature; and
providing the redacted message, the redacted signature, and a customer review to a review server.

7. The method according to claim 6, wherein the message includes a list of purchased goods and services, a serial number that uniquely identifies the redactable signature, and/or a timestamp indicating when the redactable signature was issued.

8. The method according to claim 7, wherein the encoding of the redactable parts of the message indicates that one or more of the purchased goods and services are to be redacted in the redacted message.

9. The method according to claim 6, wherein the authorization token is received via scanning a quick response (QR) code printed on a receipt and/or displayed on the service provider device.

10. The method according to claim 6, wherein the authorization token is received via near field communication (NFC) and/or through electronic messaging.

11. The method according to claim 6, wherein the redacted message is the same as the message and the redacted signature is the same as the redactable signature.

12. The method according to claim 6, wherein the redactable signature was generated using a private key and the redacted signature is generated based on the redacted message and on a result of verifying the redactable signature with a public key.

13. The method according to claim 6, wherein the review server facilitates provision of a review website, and the redacted message, the redacted signature, and the customer review are provided on the review website such that validity of the redacted signature is verifiable by a user device.

14. A trustworthy review system for verifying that a customer review is legitimate, the system comprising a review server having one or more processors which, alone or in combination are configured to provide for performance of the following steps:
receiving, via a service provider device, a verification key;
receiving, via a customer device, a customer review, a redacted message, and a redacted signature; and
at least one of:
publishing the verification key and the redacted signature on a review website with the customer review such that the legitimacy of the redacted signature is checkable by a user device; or
checking, using the verification key, whether the redacted signature is legitimate and, based on the redacted signature being legitimate, marking the customer review as being legitimate.

15. The trustworthy review system according to claim 15, further configured to store the customer review in a review database based on the checking determining that the redacted signature is legitimate and to not store the customer review in the database based on the checking determining that the redacted signature is not legitimate.
